(19) United States
(12) Patent Application Publication
(10) Pub. No.: US 2011/0201263 A1
(43) Pub. Date: Aug. 18, 2011

(54) NATURAL AIR VENTILATION SYSTEM FOR A VEHICLE CAB

(76) Inventors: Karthik Srinivasan, Maharashtra (IN); Abhishek Shah, Maharashtra (IN); Rohan Gejji, Maharashtra (IN); Dhruv Kumar Jha, Maharashtra (IN)

(21) Appl. No.: 13/120,762

(22) PCT Filed: Sep. 24, 2009
(86) PCT No.: PCT/IN2009/000524

§ 371 Date: Apr. 18, 2011

(30) Foreign Application Priority Data
Sep. 25, 2008 (IN) 2052/MUM/2008

(51) Int. Cl. B60H 1/24

(52) U.S. Cl. 454/141

(57) ABSTRACT

A natural air ventilation system for vehicle cabin comprising a scoop provided to a front side of the cabin and one or more air ducts connected to said scoop to allow outside air into the cabin, an exit vent at the rear wall of the said cabin, the exit vent of rear wall connected by duct means to a snorkel having a matching vent to form tight air passage, the snorkel outlet is connected to an intake manifold of an engine through an air fitter such that when the engine is running intake air to said manifold includes a portion of air of cabin space through the said exit vent of cabin and a portion of outside air through an opening on the snorkel.

### TECHNICAL FIELD OF THE INVENTION

The present invention relates to air ventilation system for occupant of the vehicle cabs. More particularly the invention relates to fresh air ventilation and removal of stagnant air from cabin of a vehicle using the suction power of engine.

### BACKGROUND AND PRIOR ART SEARCH

Vehicle cabins such as truck cabins are made to occupy at least two people—the driver and the co-driver and their belongings depending on the applications for which the vehicles are used. Since the trucks are also used on long hauls and in varying atmospheric conditions ranging from hot and humid to cold and dry, the comfort of the occupants is taken care by installing a HVAC unit or a blower system in the cabin. The HVAC system is made up of a blower, compressor, condenser, pump and an evaporator at the least and derives power either from the engine or from an external device like an electrical battery. This system thus puts an extra cost on the truck manufacturer and consequently on the customer. In other cases where the HVAC is not used, ventilation is brought about by blowing air into the cabin using a blower. But this alternative also incurs additional cost and uses engine power to run the blower.

In the Indian scenario manufacturers provide most of the cabins without a HVAC system to reduce the cost of the trucks. Even the blowers are also done away with and consequently there is no way of ensuring proper air flow into the cabin. The occupant comfort is hence largely neglected. The fresh air intake is either provided in the cabins through rudimentary ductwork or only cutouts on the front of the cabin. This approach provides little control on air flow into the cabin. The biggest disadvantage of the system is that there is no proper air circulation pattern. Also such systems don't ensure removal of stagnant air from the cabin.

U.S. Pat. No. 6,004,202 presents truck cab ventilation system which includes an air exhaust channel that extends from an upper channel portion adjacent the ceiling at the rear of the cab and through a lower channel portion and to an exhaust vent mounted adjacent the floor of the cab over an exit opening in such floor. An inlet vent in the front of the cab produces a positive pressure within the cab which causes flow-through ventilation air flow from the front to the rear of the cab when the truck is moving. As a result, air flows into the upper channel portion of the exhaust channel and out of the exhaust vent through the exit opening to the exterior of the cab. The exhaust vent includes flexible louvers of the elastomer which are held by gravity in a closed position and are moved into an open position when air flows out through the exhaust system.

Patent Nos. CA 2324687, U.S. Pat. No. 6,361,428 and ZA 200006180A disclose vehicle ventilation system mounted to the upper portion of the exterior structure of a vehicle's occupant cabin. The components of the exterior structure of the occupant cabin define an opening through the exterior structure of the occupant cabin in the upper portion of the occupant cabin. A duct is mounted to the exterior structure of the occupant cabin and has a first end in fluid communication with the opening in the exterior structure of the occupant cabin. A second end of the duct is positioned below the first end of the duct and is open to and in fluid communication with the outside atmosphere. A fan is mounted to the exterior structure of the occupant cabin and is positioned such that when in operation it can be operated to move air through the opening in the exterior structure of the occupant cabin. The fan is controllable to change the rate and direction of the flow of air which it creates. A first rotary damper is mounted over the opening in the exterior structure of the occupant cabin and can be selectively opened or closed to allow or prevent air flow through the opening in the exterior structure of the occupant cabin. A second damper is mounted in a position such that it radially surrounds the impeller of the fan and can be used to control the flow of air radially outward from or radially inward toward the impeller of the fan.

U.S. Pat. No. 6,361,429 describes an automotive ventilation system comprising two blowers, a front mounted blower that pulls outside air in, and a rear mounted fan that exhausts interior air from the cabin space. By pulling and pushing in series, the speed of each blower is reduced, and the attendant blower noise is considerably reduced. In addition, a closed floor duct routes re circulated air from the rear to the front blower, eliminating the conventional open blower noise path to the vehicle interior in recirculation mode.

In this concept extra mechanical means are provided to take air inside the cabin and to exhaust it from the vehicle cabin involving more number of components.

Patent No. GB 2341676 states about vehicle air ventilation system. A cabin air intake system for a road vehicle has an air ventilation and climate control unit positioned below the windscreen of the vehicle for supplying conditioned ambient air through the dashboard to the passenger cabin of the vehicle. The cabin air intake system comprises two air intake openings positioned to draw ambient air from an upper section of the vehicle higher than the centre of the windscreen of the vehicle. Two air intake ducts are connected from the respective air intake openings to the air ventilation and climate control unit, and are routed along the respective A-pillars of the vehicle.

U.S. Pat. No. 6,186,886 describes vehicle cabin cooling system for capturing and exhausting heated boundary layer air from inner surfaces of solar heated windows. The system includes a cooling duct positioned proximate and above upper edges of one or more windows of a vehicle to exhaust hot air and at least one fan to draw hot air into the cooling duct.

In this air circulation system also exhaust fan is used to draw the hot air from the cabin. Air inlet vents are provided at the bottom of the vehicle which may take dirt inside the cab along with air.

Patent application Nos. EP 1623860, CN 1733517, FR 2873954, JP 2006046899 and US 2006/0026936 describe an air ventilation module for a vehicle cabin comprising of housing able to be installed in a chosen location in the cabin. The housing has air inlet and at least one air outlet and accommodating an air propulsion member comprising at least one motor and a rotary element for moving the air which is accommodated in an internal chamber of the housing. The module can also comprise a filtering element.

This system has external propulsion member for movement of the air and it is an add-on module to the vehicle cabin.

As disclosed in patent application No. US 2007/0249278, the cabin exhaust device ventilates vehicles provided with retractable windows and mounts on a portion of the vehicle, preferably on a door frame or in an opening between a window panel and a window frame.

The cabin exhaust device comprises a squeegee and a ventilation panel having an air dam, a first portion, and a second portion, wherein the first and second portions are provided with angularly oriented apertures, thereby creating a vacuum on the vehicle's interior side. The first and second portions are outwardly convexed, thereby facilitating the creation of a pressure differential between the vehicle's interior and its exterior, thus forcing the air and other contaminants out from the vehicle's interior.

Patent application No. WO 2002/083441 discloses aeration system for excavators and industrial vehicle cabins comprising diffusers built into horizontal elements and vertical supports which delimit the transparent side surfaces of the cabin are designed to direct ventilation air flows in the vicinity of said transparent side surfaces, thus producing uniform ventilation close to the operator's body.

In this system air is forced to inside the cabin. The system is noisy does not disclose about the exit of inside air from the cabin.

### DEFICIENCIES OF PRIOR ART

Most of the cab ventilation systems in prior art are provided with extra mechanical means such as blowers, exhaust fans for movement of the air inside the cabin.

Most of the present day systems and prior art concepts are heavily dependent on the ram effect of air from the front of the cabin or an external power source.

When the drivers roll up windows in dust/rainy/polluted conditions, there is little air flow into the cabin, thus causing discomfort/suffocation.

These problems get aggravated when the vehicle is moving at low speeds and the ram effect of air is negligible.

The biggest disadvantage of these systems is that there is no proper established air circulation pattern.

The approach used in prior art techniques provides little or no control over air flow in the cabin and does not necessarily ensure removal of stagnant air from the cabin.

### OBJECT OF THE PRESENT INVENTION

The main object of the invention is to provide fresh air ventilation system throughout the vehicle cabin by having cross cabin (front to back) air circulation pattern, especially when the windows are rolled up (when the truck is operating in mining areas/rainy season/city condition) even at low/zero speeds.

Another object of the invention is to provide a mechanism that ensures removal of stagnant air from the cabin to enhance occupant comfort, even at low/zero vehicle speed.

Yet another object of the invention is to provide an alternative solution to high cost HVAC and/ or blower units.

Still another object of the invention is to provide low cost and efficient fresh air ventilation system for vehicle cabins.

### STATEMENT OF PRESENT INVENTION

Accordingly present invention provides Natural air circulation system, for vehicle cabin with enclosed space having front, rear and side walls, comprising a scoop provided to said front side wall at out side and one or more air ducts inside the cabin connected to said scoop to allow out side air into the cabin; an exit vent is cut at rear wall of the said cabin; the said exit vent of rear wall is connected by duct means to snorkel having matching vent to form tight air passage; and snorkel out let is connected to intake manifold of engine through air fitter such a way that when the engine is running, the intake air to said manifold includes a portion of air inside the cabin space through the said exit vent of cabin and partly out side air through an opening on the said snorkel.

### DESCRIPTION OF THE FIGURES

FIG. 1 shows the schematic side view of the air ventilation system for vehicle cabin for one of its embodiments as disclosed herein.

FIG. 2 shows the rear view of air ventilation system with air flow through the snorkel in accordance with one of the embodiments of the present invention.

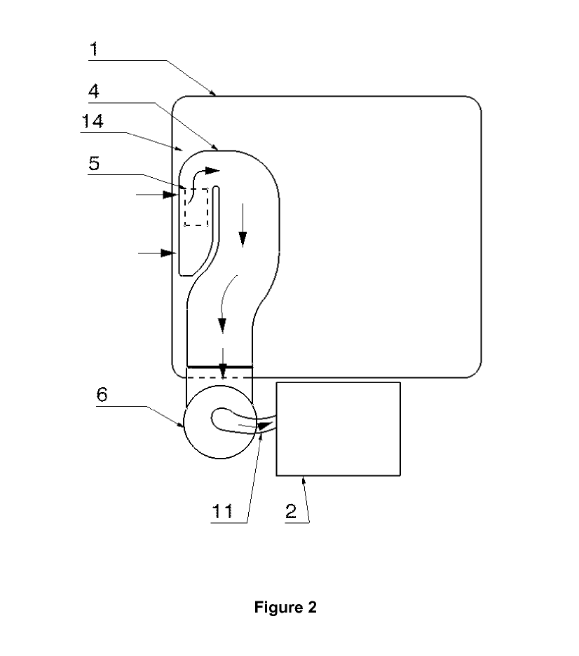

### DETAILED DESCRIPTION OF THE INVENTION

The foregoing objects of the invention are accomplished and the problems and shortcomings associated with prior art techniques and approaches are overcome by the present invention as described below in the preferred embodiment.

This invention is illustrated in the accompanying drawings, through out which like reference letters indicate corresponding parts in the various figures.

For better understanding of the description of the present invention, drawings are enclosed wherein one of the embodiments of the fresh air ventilation system for vehicle cab is shown.

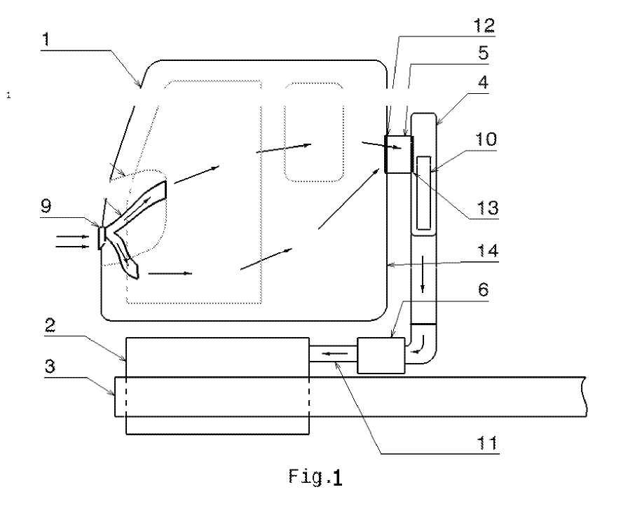

Referring to FIG. 1, vehicle cab (1) is provided with fresh air ventilation system comprising air scoops (9), air duct (8), exit vent (12), snorkel duct (5) and snorkel (4). Air scoops (9) and air ducts (8) are provided at the front part (7) of the vehicle cabin (1) to bring in fresh air inside the cabin. The area of the air scoop (9) and the air duct (8) is designed as per the requirement of air flow into the vehicle cabin (1). The positions of the air duct outlets (8) inside the vehicle cabin (1) are so placed as to provide air circulation patterns across the entire volume of the cabin (1). The air ducts (8) are provided with wire mesh filters (not shown in figure) to avoid the ingress of dust, dirt, other foreign material and like unwanted things. The air scoop (9) at the front of the vehicle cab (1) is designed such a way that upper edge of the scoop protrudes outside cab body (like a rain-shade in layman's language) which prevents direct entry of water into the duct. The lower edge of the scoop is at a certain angle which makes the water droplets, entered there by any means, to roll down outside, thus preventing entry of water into the duct (8).

The exit vent (12) is cut out on the rear wall (14) of the vehicle cabin (1). Another cut out vent (13) is provided on the snorkel (4) corresponding to the exit vent (12). A snorkel duct (5) connects the exit vent (12) on the rear wall (14) of the vehicle cab (1) and cut out vent (13) on the snorkel (4) to form an air tight passage. A wire mesh (not shown in figure) is provided at the exit vent (12) to prevent the entry of unwanted material such as pieces of paper or other such dirt that can go down the snorkel (4) and choke the air filter unit (6).

When the engine (2) is running, a suction pressure is created in the snorkel (4) which sucks in fresh air through it. Thus, the engine (2) sucks in air from outside atmosphere through opening (10) on the snorkel (4) and from the vehicle cabin (1) through exit vent (12) on the rear wall (14) of the vehicle cab (1). This air goes down the snorkel (4), gets filtered at the air filtration unit (6) and then goes to the air intake manifold of the engine (2) through a hose pipe (11). The air sucked in from the vehicle cabin (1) will be a portion of the total air sucked by the intake manifold. The amount of air sucked from the vehicle cab will depend on the ratio of cross sectional area of snorkel duct (5) to the snorkel opening area (10) on the snorkel (4). This operation will create a low pressure zone in the vehicle cabin (1). Air pressure difference inside the vehicle cabin (1) and ambient atmospheric air results in entry of fresh air into the vehicle cabin (1) through the air scoops (9) and air ducts (8) fitted at the front of the vehicle cabin (1). This will be assisted by the ram effect of the ambient air when the vehicle is in motion. This system works best when the windows are rolled up.

A simple flap mechanism/system shut off mechanism, is provided to close the exit vent (12) when the operation of the natural air ventilation mechanism is not required. A mechanism to regulate flow of air out of vehicle cabin (1) through exit vent (12) can also be developed using louvers that will vary cross-sectional area of exit vent (12) depending on the engine suction. This kind of a system can be coupled with a blower, thus ensuring even more effective air flow patterns.

Air scoop, air duct, snorkel duct and snorkel is made of any suitable material such as metal or fiber reinforced plastic or combination of thereof fulfilling the functional and technical requirements. Air scoop, air duct, snorkel duct and snorkel is having cross sectional shape of square, or rectangular, or circular, or pentagonal and like fulfilling the functional requirements.

This system also works for cabins which don't have any kind of inlet ducts, but only a cutout(s) on the cabin body to let in air into the cabin.

The foregoing objects of the invention are accomplished and the problems and shortcomings associated with prior art techniques and approaches are overcome by the present invention described in the present embodiment.

Detailed descriptions of the preferred embodiment are provided herein; however, it is to be understood that the present invention may be embodied in various forms. Therefore, specific details disclosed herein are not to be interpreted as limiting, but rather as a basis for the claims and as a representative basis for teaching one skilled in the art to employ the present invention in virtually and appropriately detailed system, structure or matter.

The embodiments of the invention as described above and the methods disclosed herein will suggest further modification and alterations to those skilled in the art. Such further modifications and alterations may be made without departing from the spirit and scope of the invention; which is defined by the scope of the following claims.

### ADVANTAGES OF THE PRESENT INVENTION

The system provides air ventilation even at standstill/low vehicle speeds and even in the absence of rammed air into the cabin.

The system eliminates consumption of power from the engine or electrical battery storage for vehicle cabin ventilation.

The system removes stagnant air from the cabin and provides established air circulation patterns.

It is extremely low cost solution for air ventilation of vehicle cabs.

Replacement cost of the system is low.

The system is easy to maintain and service.

1.-10. (canceled)

11. A natural air ventilation system for a vehicle cabin with enclosed space, the vehicle cabin having a front wall, a rear wall and sidewalls, comprising:
a scoop located outside of the front wall, one or more air ducts inside the cabin wherein the air ducts are connected to said scoop to allow outside air into the cabin;
an exit vent in the rear wall of the cabin; and
a snorkel connected by a duct means to the exit vent and having a matching vent to form a tight air passage, the snorkel having an outlet connected to an intake manifold of an engine through an air fitter such that when the engine is running, the intake air to the manifold includes a portion of air inside the vehicle cab space through the exit vent and portion of outside air through an opening on the snorkel.

12. The system of claim 11, wherein the upper edge of the scoop protrudes outside the cabin body to prevent direct entry of water into the air ducts and the lower edge of the scoop is maintained at a certain angle for rolling down droplets outside.

13. The system of claim 11, wherein the air ducts are fitted with fine wire mesh filters to avoid the ingress of dust and foreign material.

14. The system of claim 11, wherein the air ducts inside the cabin are positioned so as to provide air circulation patterns across the entire volume of the cabin.

15. The system of claim 14, wherein the air circulation inside the cabin is dependent on the ration of cross sectional area of the duct means to the opening on the snorkel.

16. The system of claim 14, wherein louvers are provided to the exit vent of the cabin to vary cross sectional areas of the duct means and to control the air circulation inside the cabin.

17. The system of claim 11, wherein a simple flap shut off mechanism is provided to close the exit vent to stop natural air ventilation.

18. The system of claim 11, wherein the exit vent is provided with wire mesh to prevent entry of unwanted material such as pieces of paper or other such dirt that may enter the snorkel and choke the air filter.

19. The system of claim 11, wherein the scoop, the air duct and the snorkel are made from metal, fiber, or reinforced plastic or a combination thereof.

20. The system of claim 11, wherein the cross sectional shape of the scoop, the air duct, the snorkel and the snorkel duct is a square, rectangular, or pentagonal shape.
